(19) United States
(12) Patent Application Publication
(10) Pub. No.: US 2008/0065671 A1
(43) Pub. Date: Mar. 13, 2008

(54) Methods and apparatuses for detecting and labeling organizational tables in a document

(75) Inventors: Herve Dejean, Grenoble (FR); Jean-Luc Meunier, St Nazaire les Eymes (FR)

Correspondence Address: FAY SHARPE / XEROX - ROCHESTER, 1100 SUPERIOR AVE., SUITE 700, CLEVELAND, OH, 44114, US

(73) Assignee: XEROX CORPORATION

(21) Appl. No.: 11/517,092

(22) Filed: Sep. 7, 2006

(51) Int. Cl. G06F 17/00

(52) U.S. Cl. 707/102

(57) ABSTRACT

A document (10) includes one or more organizational tables (40). Each organizational table includes a substantially contiguous sub-set of text fragments of the document identified as entries of the organizational table, and each entry has an associated linked text fragment. An organizational tables scorer (42) assigns a score to each of the one or more organizational tables respective to at least one object type based on a scoring criterion for that object type. An organizational tables labeler (44) assigns a table type label to each of the one or more organizational tables based on the scores.

### CROSS REFERENCE TO RELATED PATENTS AND APPLICATIONS

The following U.S. patent applications are commonly owned with the present application and are each incorporated herein by reference.

Meunier et al., “Rapid Similarity Links Computation For Table of Contents Determination” (Xerox ID 20051557-US-NP, Ser. No. 11/360,951 filed Feb. 23, 2006) is incorporated herein by reference in its entirety. This application relates at least to table of contents extraction with improved robustness.

Meunier et al., “Table of Contents Extraction with Improved Robustness” (Xerox ID 20051557-US-NP, Ser. No. 11/360,963 filed Feb. 23, 2006) is incorporated herein by reference in its entirety. This application relates at least to table of contents extraction with improved robustness.

Dejean et al., “Structuring Document based on Table of Contents,” (Xerox ID 20040970-US-NP, Ser. No. 11/116,100 filed Apr. 27, 2005) is incorporated herein by reference in its entirety. This application relates at least to organizing a document as a plurality of nodes associated with a table of contents.

Dejean et al., “Method and Apparatus for Detecting a Table of Contents and Reference Determination,” Ser. No. 11/032,814 filed Jan. 10, 2005 and published on Jul. 13, 2006 as U.S. Publ. Appl. 2006/0155703 A1 is incorporated herein by reference in its entirety. This application relates at least to a method for identifying a table of contents in a document. An ordered sequence of text fragments is derived from the document. A table of contents is selected as a contiguous sub-sequence of the ordered sequence of text fragments satisfying the criteria: (i) entries defined by text fragments of the table of contents each have a link to a target text fragment having textual similarity with the entry; (ii) no target text fragment lies within the table of contents; and (iii) the target text fragments have an ascending ordering corresponding to an ascending ordering of the entries defining the target text fragments.

### BACKGROUND

The following relates to the document and information management and storage arts. It particularly relates to document conversion systems and methods for converting documents to a common structured format, and is described with illustrative reference thereto. The following relates more generally to systems and methods for processing documents to identify and label organizational tables such as tables of contents, tables of figures, tables of tables, and so forth.

There is significant interest and activity in developing document migration systems and methods. Corporations, government agencies, and other large, established entities typically have a large corpus of legacy documents that have been prepared in various diverse formats, such as various different word processing formats, spreadsheet formats, presentation formats, portable document format (pdf), and so forth. It has been recognized that these diverse formats negatively impact information retrieval and use, which limits the value of the corpus of legacy documents.

Moreover, the use of diverse and typically unstructured formats makes it difficult to locate relevant legacy documents. Even if appropriate software can be obtained to retrieve and access a legacy document, the lack of a common organizational paradigm makes it difficult to decide which legacy document or documents should be retrieved and reviewed. Legacy document formats that are largely unstructured provide little or no content organization, and hence provide no convenient way to group or search the legacy documents to find specific information.

A solution to these problems is to convert or migrate legacy documents to a common structured format, such as extensible markup language (XML), hypertext markup language (HTML), standard generalized markup language (SGML), or so forth. These structured formats typically employ a conceptual treelike organization in which content is disposed at terminal leaves and higher-level nodes provide groupings or other structuring of the content. Additionally, in some structured formats the content can be annotated so as to further facilitate grouping and searching.

The document structuring in the structured format preferably comports with the content layout of the document. Accordingly, there is interest in extracting the content layout of an unstructured or shallowly structured document. A potential source of content layout information are the organizational tables of a document, such as the table of contents and any tables of objects such as a table of figures, table of images, table of tables, or so forth. In an unstructured or shallowly structured document, these organizational tables are typically stored integrally with the content of the document. This makes it difficult to discern and extract the organizational tables from the content of the document.

Techniques have been developed to discern and extract a table of contents that is integrally stored with the content of a document. However, some of these techniques make assumptions that compromise their robustness when applied to a document that has a plurality of organizational tables. For example, some table of contents extractors assume there is only one organizational table, namely the table of contents. Some techniques assume that the organizational table is near the beginning of the document. Some techniques assume a particular font or other text characteristic is common to all organizational tables of the document. When a document includes multiple organizational tables, these existing table extraction techniques are unable to robustly extract the different organizational tables.

Moreover, if multiple organizational tables are successfully extracted, existing techniques typically do not provide a way to distinguish amongst the different extracted organizational tables. It will be appreciated that different documents may have substantially different numbers and kinds of organizational tables. Some documents, for example, may be multi-chapter or multi-volume documents in which each chapter or volume has its own table of contents and possibly other organizational tables such as a table of figures. Some documents may have only a single organizational table of each type. Different documents will in general have different kinds of organizational tables—for example, some documents may include a table of images, while other documents may not. In the latter case, the document may or may not include images. Knowledge of the number and type of each organizational table in a document is advantageous for using such organizational tables in structuring the document.

### BRIEF DESCRIPTION

Apparatus and method embodiments are disclosed.

An example apparatus processes one or more organizational tables of a document. Each organizational table includes a substantially contiguous sub-set of text fragments of the document identified as entries of the organizational table, and each entry has an associated linked text fragment. The apparatus includes an organizational tables scorer that assigns a score to each of the one or more organizational tables respective to at least one object type based on a scoring criterion for that object type. An organizational tables labeler assigns a table type label to each of the one or more organizational tables based on the scores.

An example method processes one or more organizational tables of a document. Each organizational table includes a substantially contiguous sub-set of text fragments of the document identified as entries of the organizational table, and each entry has an associated linked text fragment. The method includes: scoring each organizational table respective to at least one object type based on proximity of the associated linked text fragments of the organizational table to objects of the at least one object type; and assigning a table type to each of the one or more organizational tables based on the scores.

An example apparatus for structuring a document includes: a text fragmenter configured to extract an ordered sequence of text fragments from the unstructured document; an organizational tables extractor configured to extract one or more organizational tables from the ordered sequence of text fragments, each organizational table including a substantially contiguous sub-set of text fragments of the document identified as entries of the organizational table, each entry having an associated linked text fragment; an organizational tables labeler configured to assign a table type label to each organizational table based on at least one of (i) content of at least one of the entries and the linked text fragments and (ii) proximities of the linked text fragments with respect to objects in the document; and a document organizer configured to structure the document based on the labeled organizational tables.

### BRIEF DESCRIPTION OF THE DRAWINGS

FIG. 1 diagrammatically shows an apparatus for identifying and labeling organizational tables in a document, and for structuring the document based on these organizational tables.

FIG. 2 shows a similarity matrix for a document consisting of fifteen text fragments.

FIG. 3 diagrammatically shows an identified organizational table.

FIG. 4 diagrammatically shows a page of a document. The diagrammatically shown page includes three images with captions and a table.

FIG. 5 diagrammatically shows parameters used in computing a proximity measure of a linked text fragment respective to an object of a selected object type.

### DETAILED DESCRIPTION

As used herein, the term “table of contents” is intended to encompass any table listing locations of chapters, sections, or other divisions of a document. As used herein, the term “table of objects” is intended to encompass any table listing locations of objects in a document. For example, a table of objects may be: a table of images listing locations of images in a document; a table of figures listing locations of figures in a document; a table of tables listing locations of substantive tables in a document (the term “substantive table” being used here to denote a table containing content of the document as opposed to an organizational table that provides organization to the document); a table of panels listing locations of panels containing special information offset from the general flow of text; a table of textboxes listing locations of textboxes offset from the general flow of text; or so forth. The term “organizational table” is intended to encompass both tables of contents and tables of objects, but not substantive tables that contain content of the document.

A document typically includes a table of contents and optionally one or more tables of objects. However, it is contemplated for the document to include one or more tables of objects without a table of contents, or for the document to include a table of contents without any tables of objects. It is contemplated for the document to include more than one table of contents (for example, an overall table of contents for a multiple-chapter document along with a table of contents for each chapter). It is contemplated for the document to include more than one table of objects of the same object type (for example, a table of figures for each chapter of a multiple-chapter document) either alone or in addition to a table of contents or table of objects of another type.

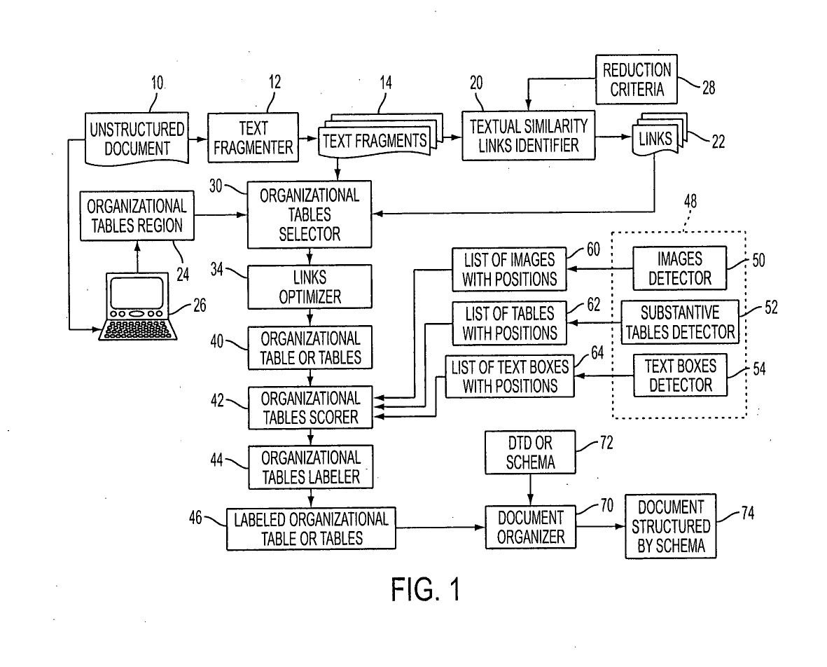

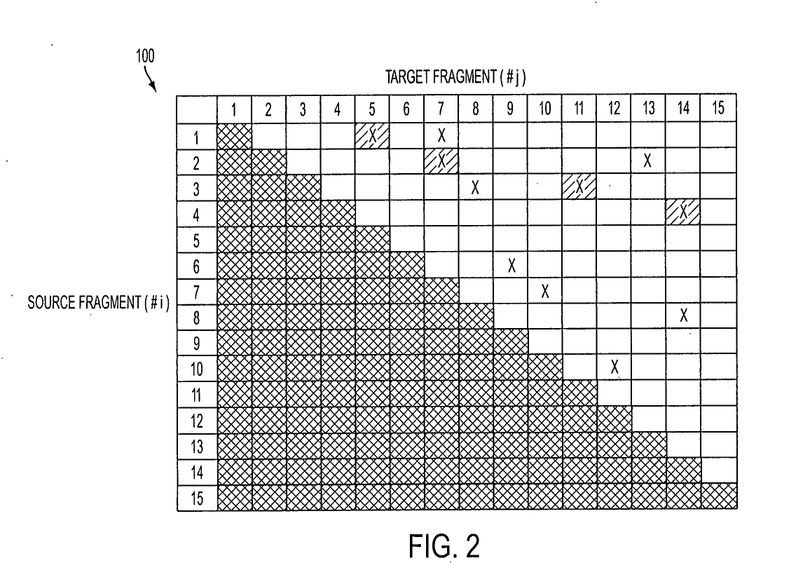

The locations of document divisions or objects are typically specified in an organizational table by page numbers; however, other location identifiers are also contemplated, such as specifying location by volume, section, chapter, or so forth, or by some combination of location specifiers such as a volume number and a page number within that volume. In addition to listing the locations of document divisions or objects in the document, an organizational table optionally lists summary or capsule information about the document divisions or objects, such as section heading text, caption text, or so forth. The organizational table may also list document division or object enumerators, such as for example, “FIG. 1”, “FIG. 2”, and so forth in the case of a table of figures.

In an unstructured or shallowly structured document, the organizational table or tables are typically stored integrally with the content of the document. Various techniques can be used for extracting such organizational tables from the document. The output of the organizational tables extractor is one or more organizational tables each including a set of text fragments (possibly represented by pointers to text fragments within the document) corresponding to entries of the organizational table, in which each entry has an associated linked text fragment (again, possibly represented by a document pointer) such as a corresponding chapter heading, section heading, object caption, or so forth. The association or linkage between entries and corresponding linked text fragments (e.g., headings or captions) can be recognized and quantified or ranked based on various criteria, such as use of distinctive heading font size and/or font style, arrangement of text fragments on a page, common textual content or textual similarity, or so forth.

With reference to FIG. 1, an illustrative example organizational table extraction approach based on textual similarity of text fragments, rather based on font characteristics, physical page layout, or so forth, is described. Insofar as font characteristics, page layout, and so forth may be lost or modified during document conversion processes or when the document is stored in certain formats (such as plain text), the example textual similarity-based organizational table extractor has certain advantages in terms of robustness.

With reference to FIG. 1, an unstructured document 10 is provided, and a text fragmenter 12 breaks the unstructured document 10 into an ordered sequence of text fragments 14. Typically, the unstructured document 10 is loaded as a list of text strings from a text or XML file produced from a document in an input format (such as Adobe PDF, Word FrameMaker, or so forth), using an off-the-shelf converter. A paper document is suitably scanned using an optical scanner and processed by optical character recognition (OCR). For a text document, each line suitably becomes a fragment ordered line by line. For an XML or HTML document, each PCDATA suitably becomes a text fragment. Several strategies can be used to order the textual fragments: depth-first left-to-right traversal (document order) or use of the fragment position in the page. Also, the relationship between XML nodes and text fragments can be preserved in order to map the detected table of contents and references back onto XML nodes at the end of the process. It is to be appreciated that the text fragmenter 12 can fragment the textual content in lines, blocks, series of words of a line, or even may split a word across two text fragments (for example, due to a different formatting on the first character of the first word of a title).

The resulting ordered sequence of text fragments 14 is processed by a textual similarity links identifier 20 that identifies links 22. Each link is defined by a pair of textually similar text fragments. The text fragments of the pair defining the link are identified herein as source and target text fragments. The source text fragment is a candidate for being an entry of an organizational table, while the target text fragment is a candidate linked text fragment.

There are various ways of defining or identifying such pairs of text fragments. In general, for N fragments, the computation of links is of order O(N²). Additionally, the possible presence of noise in the text should be accounted for. Noise can come from various sources, such as incorrect PDF-to-text conversion, or organizational table-specific problems such as a page number that appears in the organizational table contents but not in the document body, or a series ellipses ( . . . ) that relate the page number to descriptive text in the organizational table. In some embodiments, each text fragment is tokenized into a series of alphanumeric tokens with non-alphanumeric separators such as tabs, spaces, or punctuation signs. In some embodiments, a Jaccard is used to measure textual similarity. The Jaccard is computed as the cardinal of the intersection of the two token sets defined by candidate source and target text fragments divided by the cardinal of the union of these two token sets. A link is defined for those pairs in which the Jaccard measure is above a selected matching threshold. In other embodiments an edit distance or other suitable measure is used as the textual similarity comparison. For an edit distance measure, the threshold is a maximum—those pairs having an edit distance less than an edit distance threshold are designated as textually similar pairs.

With brief reference to FIG. 2, the textual similarity links are suitably visualized using a similarity matrix 100. Designating as (#i, #j) a link between a source text fragment #i and a target fragment #j, if a link (#i, #j) satisfies the threshold or other link selection criterion, then the link (#j, #i) also satisfies the threshold or other link selection criterion. Thus, the similarity matrix elements need only be computed for the upper-right half (or equivalently, lower left-half) of the similarity matrix 100. In FIG. 2, links in which the computed Jaccard exceeds a selected threshold are indicated by “X” marks in the link cells. Moreover, although not shown in FIG. 2 it will be appreciated that each link exceeding the threshold has an associated Jaccard or other metric value that indicates the strength of the link in terms of textual similarity.

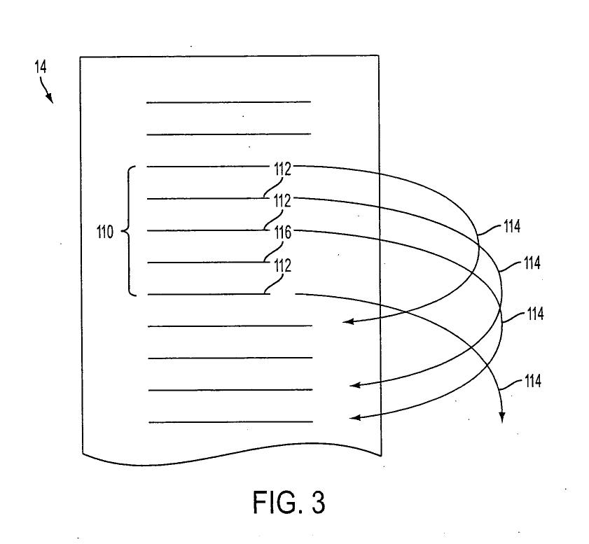

With reference to FIG. 3, an organizational table 110 represents a contiguous sub-sequence of the ordered sequence of text fragments 14. Four general criteria are used to distinguish and identify the organizational table 110 within the ordered sequence of text fragments 14. The first criterion is contiguity. The organizational table includes a contiguous sub-sequence of the ordered sequence of text fragments 14. Most of the text fragments of this contiguous sub-sequence are expected to be entries 112 of the organizational table. Each entry of the organizational table is linked to a portion of the text that follows the organizational table by one of the links 22. These links that are associated with the organizational table 110 are indicated in FIG. 3 as curved arrows 114. It is to be appreciated that the links 114 of the organizational table 110 are a sub-set of the links 22 computed by the textual similarity links identifier 20. However, the links 22 typically include many links in addition to the sub-set of links 114. The sub-set of links 114 denote linked text fragments that correspond with entries of the organizational table.

Although most of the text fragments of the organizational table 110 are entries 112, a small portion of the text fragments in the contiguous sub-sequence of text fragments defining the organizational table 110 may be holes, rather than entries 112. The holes do not have associated links 114, and do not represent an entry of the organizational table linking to another portion of the document. An example hole 116 is shown in FIG. 3. Typically, a ratio of the number of holes to the number of entries is less than about 0.2. In some embodiments, the maximum acceptable number of holes is a user-selectable parameter. Thus, the entries of the organizational table form a substantially contiguous group of text fragments in the sub-sequence 14.

The second criterion is textual similarity. Each link 114 should connect an entry 112 to a document division heading, object caption, or other linked text fragment having text that is similar to the text of the entry. The textual similarity is suitably measured by the Jaccard or other text similarity measure employed by the textual similarity links identifier 20. The target or linked text fragment is typically a heading of a chapter, section, or other document division in the case of a table of contents, or a caption or heading in the case of a table of objects. For example, in the case of a table of figures the target or linked text fragment may be a figure caption. In the case of a table of tables the target or linked text fragment may be a heading or caption of a substantive table. In general, the heading or caption of an object may be above, below, to the side of, or otherwise positioned respective to the corresponding figure, table, or other object.

The third criterion is ordering. The target or linked text fragments of the links 114 should have an ascending ordering corresponding to the ascending ordering of the entries 112. That is, for a set of entries {#i₁, #i₂, #i₃, . . . } having a set of links {(#i₁,#j₁), (#i₂,#j₂), (#i₃,#j₃), . . . } where the set of entries {#i₁, #i₂, #i₃, . . . } have an ascending ordering, it should follow that the ordering of the corresponding set of target fragments {#j₁, #j₂, #j₃, . . . } is also ascending.

The fourth criterion is lack of self-reference. All of the links 114 should initiate from within the organizational table 110, and none of the links 114 should terminate within the organizational table 110. The set of entries {#i₁ #i₂, #i₃, . . . } and the corresponding set of target text fragments {#j₁, #j₂, #j₃, . . . } should have an empty intersection, and moreover none of the target text fragments {#j₁, #j₂, #j₃, . . . } should correspond to a hole text fragment in the organizational table 110.

With reference to FIG. 1, in some embodiments one or more contiguous sub-sets of the text fragments are identified as an organizational tables region 24. For example, a user interface 26 can be configured to receive a user identification of the organizational tables region 24. As one example, the user may scan in the source document 10, and at the time of scanning indicate which scanned page or pages contain the organizational table or tables. Then, when the text fragmenter 12 fragments the source document 10 to produce the text fragments 14, those text fragments extracted from the page or pages indicated by the user as containing the organizational table or tables are assigned as the organizational tables region 24.

With reference to FIG. 1, in some embodiments, one or more reduction criteria 28 are applied by the textual similarity links identifier 20 to reduce the number of text fragments that are candidates for identification as linked text fragments. For example, the reduction criteria 28 may include one or more regular expressions with which text fragments are compared. Text fragments that match the regular expression (or, alternatively, which do not match the regular expression) are excluded as candidates for identification as linked text fragments. For example, the regular expression may set forth an indexing text fragment portion such as a leading numeric index, a leading alphabetic index, a leading roman numeral index, or so forth, and text fragments that do not match or satisfy the indexing fragment portion defined by the regular expression are excluded from consideration as candidate linked text fragments. This approach is useful where the organizational table or tables are indexed by, for example, a chapter number (e.g., Chapter 1, . . . . Chapter 2, . . . , etc.), alphabetic section index (e.g., “A. Introduction”, . . . “B. Description of the problem”, . . . etc.), common caption starting format (e.g., “FIG. 1”, “FIG. 2”, . . . ), or so forth.

As another example, the regular expression may set forth that the text fragment contain at least one keyword typically indicative of a chapter heading, section heading, or so forth. For example, the keyword may be “part”, “section”, “chapter”, “book”, “Fig.”, “Table”, or so forth, or various combinations thereof. Text fragments which do not satisfy the regular expression because they contain none of the keywords indicative of being a heading are excluded. In some such regular expressions, the location of the keyword may be incorporated into the regular expression. For example, the regular expression may be something such as: “Chapter *” which indicates that the text fragment must begin with the capitalized word “Chapter” followed by a space and any other text (as indicated by the trailing asterisk). In other such regular expressions, the expression may be satisfied if the keyword appears anywhere in the text fragment.

Other regular expressions can be used, alone or in combination. As yet another example, the regular expression may require that the text fragment be in all-caps, so that text fragments containing lower-case letters (or more than one or two lower-case letters, or some other similar pattern) are excluded from further consideration by the textual similarity links identifier 20. While the term “regular expression” is used herein, it is to be appreciated that the comparison with the regular expression may be computationally implemented in various ways, such as using a text search algorithm (for finding a keyword in a text fragment), a finite state network-based automaton (for performing comparisons with simple or complex character string patterns), or so forth. The one or more reduction criteria 28 may also include other criteria such as restrictions on the page position of the linked text fragments, restrictions on the font, font size, font type (e.g., italic, boldface, etc.) or so forth.

With reference to FIG. 1, an organizational tables selector 30 selects one or more organizational tables based on the contiguity, text similarity, ordering, and non-self-referencing criteria. In one suitable approach, N hypotheses are tested, corresponding to N candidate starting text fragments for an organizational table. For each of the N possible starting fragments, the hypothesis “Could an organizational table start at this text fragment?” is tested. In some suitable embodiments, the testing starts at the candidate starting text fragment and then looks at each subsequent text fragment in turn to consider it for inclusion in an organizational table. The organizational table is extended by adding subsequent contiguous text fragments until the addition of a new text fragment breaks the ordering constraint. For example, if last added text fragment is a source text fragment having links to target fragments #j=15 and #j=33, and the next text fragment under consideration is a source text fragment having a link only to target fragment #j=20, then this next text fragment can be added to the organizational table since #j=20 is greater than #j=15. If, however, the next text fragment is a source text fragment only having a link to target fragment #j=12, then this would break the ordering. However, it is advantageous to relax the ordering constraint somewhat to allow for a few holes in the organizational table. This is suitably achieved by permitting the presence of a certain number of text fragments without any associated links, and by permitting a certain number of fragments with link-crossing, that is, a text fragment for which all of its associated links break the ordering constraints in the organizational table. Allowing some link-crossing is useful if for example the previous text fragment in the current organizational table contained only one link pointing too far ahead in the document.

To enforce the non-self-referencing constraint, a second pass is suitably performed once the extent of an organizational table is tentatively determined with respect to the ordering constraint. Using a second pass accounts for indeterminacy as to the end of the organizational table, as the end of the organizational table is unknown while it is being extended from its start point. The second pass starts at the original starting text fragment at the top of the organizational table. Each subsequent text fragment is tested. If a subsequent text fragment includes links only to text fragments within the organizational table, then it violates the non-self-referencing criterion—accordingly, the second pass would terminate the organizational table just before that non-self-reference violating text fragment. Again, however, it may be advantageous to allow a certain number of holes. This is suitably achieved in the second pass by allowing one or a few text fragments of the organizational table to be self-referencing. These text fragments that violate the self-referencing criterion are assumed to be holes, rather than entries, in the organizational table.

This processing is repeated for each of the N possible starting text fragments. The output of the organizational tables selector 30 is a set of one or more organizational tables, each formed of a contiguous list of text fragments corresponding to text entries. Each text entry has one or more candidate linked text fragments.

Because the organizational tables selector 30 constructed each organizational table in a way that ensures that the ordering and non-self-reference constraints can be obeyed (while optionally allowing for a limited number of holes), it follows that a links optimizer 34 can select for each entry of each organizational table one link from its list of acceptable links so that the ordering and non-self-reference constraints are respected. In the case of a document which includes several organizational tables, it is expected that the organizational tables selector 30 will output a plurality of organizational tables. A links optimizer 34 optimizes the links for each organizational table. The selection of the best link for each of the entries of an organizational table involves finding a global optimum for the organizational table while respecting the four table of contents constraints: contiguity, text similarity, ordering, and non-self-referencing. In some embodiments, a weight is associated to each candidate link, which is proportional to its level of matching. In some embodiments, a Viterbi shortest path algorithm is employed in selecting the optimized links. Other algorithms can also be employed for selecting the optimized links. The output of the links optimizer 34 is a set of one or more organizational tables 40, each including a set of substantially contiguous text fragments defining the entries and associated linked text fragments that are expected to correspond with section headings, figure captions, image captions, table headings or captions, or so forth.

The foregoing organizational tables extractor employing the textual similarity identifier 20, the organizational tables selector 30, and the links optimizer 34 is an illustrative example. Other tables extraction algorithms and systems can be employed that output the one or more organizational tables 40 in which each organizational table includes a substantially contiguous sub-set of text fragments 14 of the document 10 identified as entries of the organizational table and associated linked text fragments that are expected to correspond with section headings, figure captions, image captions, table headings or captions, or so forth.

With continuing reference to FIG. 1, the one or more organizational tables 40 are processed to assign a table type label to each organizational table. An organizational tables scorer 42 assigns a score to each organizational table respective to each object type based on a scoring criterion for that object type. An organizational tables labeler 44 then assigns a table type label to each organizational table based on the scores assigned to that organizational table. The result is a set of one or more labeled organizational tables 46. A non-limiting list of object types against which each organizational table is suitably scored by the organizational tables scorer 42 includes: image type; figure type; substantive table type; panel type; and textbox type. Suitable corresponding table type labels assigned by the organizational tables labeler 44 include: table of images type; table of figures type; table of tables type; table of panels type; and table of textboxes type. A specific system or method embodiment may include a sub-set of these types, additional or other types, or so forth. Additionally, the organizational tables labeler 44 when appropriate labels one or more organizational tables of a document with the table of contents type.

In one scoring approach, the organizational tables scorer 42 assigns a score to each organizational table based on a count of occurrences of a keyword or key phrase in entries of that organizational table, or in the linked text fragments associated with the entries of that organizational table, or in both the entries and linked text fragments of that organizational table. This scoring approach leverages the situation for certain organizational tables in which there may be a common keyword or key phrase that is used in most or all of the entries and/or in most or all of the linked text fragments. For example, in a table of tables, it is typically the case that each caption (that is, each linked text fragment) will include the keyword “Table”. This keyword may also be included in each entry of the table of tables. Similarly, each caption (that is, each linked text fragment) of a table of figures will typically include a keyword such as “Fig.” or “Figure”. Such a keyword or may also be included in the entries of the table of figures. Yet again, each caption (that is, each linked text fragment) of a table of panels will typically include a keyword such as “Panel”. This keyword may also be included in each entry of the table of panels. In one keyword or key phrase based scoring approach in which scoring is based only on the linked text fragments, a score is computed as a count of the linked text fragments containing the keyword or key phrase divided by a count of the linked text fragments. This score should be close to unity for any organizational table in which the captions include the keyword or key phrase, while it should be substantially less than unity for other organizational tables.

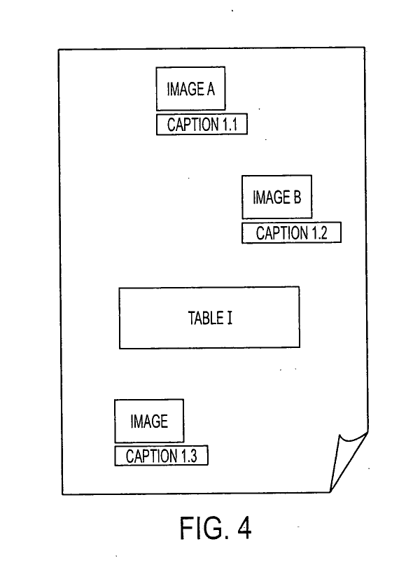

With reference to FIG. 4, in another scoring approach, the organizational tables scorer 42 assigns a score to an organizational table respective to a selected object type based on proximity of the associated linked text fragments of the organizational table to objects of the selected object type. FIG. 4 illustrates the concept. In FIG. 4, Caption 1.1, Caption 1.2, and Caption 1.3 are linked text fragments for a selected organizational table. It will be seen that Caption 1.1 has close proximity to an “Image A” of the image object type, Caption 1.2 has close proximity to an “Image B” of the image object type, and Caption 1.3 has close proximity to an “Image C” of the image object type. On the other hand, each of Captions 1.1, 1.2, and 1.3 are substantially further away from the nearest substantive table, namely a “Table I” of the substantive table object type. In view of this, the organizational table having associated linked text fragments Caption 1.1, 1.2, and 1.3 is likely to be a table of images and is unlikely to be a table of tables.

A sum of the distances of each of Caption 1.1, 1.2, and 1.3 from the closest respective image will produce a small value (that is, a low score) for the selected organizational table indicating that the selected organizational table is a table of images. On the other hand, a sum of the distances of each of Caption 1.1, 1.2, and 1.3 from the closest respective substantive table (namely “Table I” for all three captions) will produce a larger value (that is, a higher score), indicating that the selected organizational table is not a table of tables.

In such a proximity-based scoring approach, objects of the selected type, including positional information in the document, are inputs to the organizational tables scorer 42. In some embodiments, this object information may be partly or completely provided as part of the document conversion process performed by the text fragmenter 12. For example, if the text fragmenter 12 performs conversion to XML, images or certain other objects in the document may be tagged by object type. In some such XML conversion processes, a bounding box may be defined for each image, thus also providing position information.

In some embodiments, the positional information on objects in the document are provided by a suitably configured objects detector 48. For example, an images detector component 50 of the objects detector 48 detects images, a substantive tables detector 52 of the objects detector 48 detects substantive tables, and a textboxes detector 54 of the objects detector 48 detects textboxes. The images detector component 50 outputs a list of images 60 with positions, for example denoted as bounding boxes. In some embodiments, the image detector component 50 is configured to distinguish between images and icons, logos, or other specialized graphics which are not likely to be indexed in a table of images, and only images that are not icons, logos, or the like are added to the list of images 60. The substantive tables detector component 52 outputs a list of substantive tables 62 with positions, for example denoted as bounding boxes. The textboxes detector component 54 outputs a list of textboxes 64 with positions, for example denoted as bounding boxes. Any of the lists of objects 60, 62, 64 may be an empty list, if there are no objects of the corresponding object type in the document 10. Specifying the positional information using a bounding box advantageously identifies the extent of the object; however, the positional information can also be provided in another format, such as by providing coordinates of a centroid of the object, coordinates of a single corner of the object, or so forth. Moreover, while image, substantive table, and textbox detector components 50, 52, 54 are illustrated, it will be appreciated that fewer, additional, or other object detector components can be included in the objects detector 48.

Each of the detector components 50, 52, 54 suitably locates image, table, or textbox objects, respectively, by analysis of the original document 10 or by analysis of a converted or partially converted document (such as a shallow XML document) produced by the text fragmenter 12. For example, if the text fragmenter 12 includes an XML converter component that produces a shallow XML file in which objects of a certain object type are labeled, then the corresponding object detector component suitably makes use of that information. On the other hand, if the text fragmenter 12 does not provide such information, then the original document 10 is suitably analyzed in its native format to detect the objects. With the objects of the selected object type known, including positional information, the organizational tables scorer 42 suitably computes a score based on a proximity measure of the linked text fragments respective to the objects in the document.

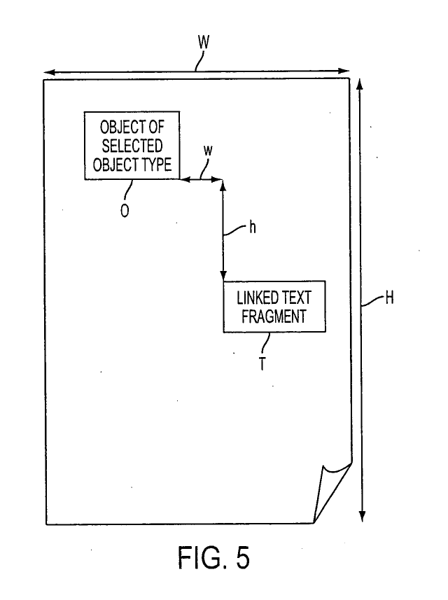

With reference to FIG. 5, one suitable proximity measure indicating closeness of a linked text fragment T with a nearest object O of the selected object type is as follows:

$${L}_{link} = 1 - {min}_{L ∈ page} ( \frac{max ( h , w )}{max ( H , W )} ) , \qquad ( 1 )$$

where the coordinates h, w indicate the vertical and horizontal distances, respectively, between the linked text fragment T and the nearest object O on the page, H, W indicate the vertical and horizontal dimensions, respectively, of the page, and Lₗᵢₙₖ is the proximity measure for the linked text fragment T. Note that the proximity measure of Equation (1) ranges between Lₗᵢₙₖ=0 and Lₗᵢₙₖ=1, with Lₗᵢₙₖ=0 corresponding to a largest distance away on the page and Lₗᵢₙₖ=1 corresponding to a zero distance (e.g., an overlap or contacting adjacency) between the linked text fragment T and the nearest object O. The score for a selected organizational table respective to a selected object type is then given by combining the proximity measures of the linked text fragments (given in Equation (1)), for example using a weighted sum:

$${( Score )}_{t} = \frac{1}{N} \cdot {\sum }_{n = 1}^{N} {( {L}_{link} )}_{n , t} , \qquad ( 2 )$$

where N is the number of linked text fragments associated with entries of the organizational table (or, correspondingly, N is the number of entries in the organizational table), the index n={1, . . . ,N} ranges over all of the linked text fragments, t indexes the selected object type, (Lₗᵢₙₖ)_{n,t} denotes the proximity measure Lₗᵢₙₖ for the nth linked text fragment respective to the nearest object of selected object type t, and (Score)ₜ denotes the score for the organizational table respective to the selected object type t. Since Lₗᵢₙₖ ranges between 0 and 1 and Equation (2) is normalized by the (1/N) factor, it follows that (Score)ₜ given in Equation (2) also ranges between 0 and 1, with higher values indicating closer proximity between objects of the selected object type t and the linked text fragments associated with the entries of the organizational table.

The positionally- or proximity-based scoring of Equations (1) and (2) is an illustrative example. Other measures of proximity of linked text fragments with respective nearest objects of the selected object type can be employed in positionally- or proximity-based scoring. In some contemplated positionally- or proximity-based scoring approaches, the score is adjusted based on whether there are any intervening elements or objects between the linked text fragment and the closest object of the selected object type. The rationale for such a scoring approach is that it is expected that there will be no intervening elements or objects between, for example, an image and its caption.

In some embodiments of the organizational tables scorer 42, different scoring approaches may be used for different object types. For example, if it is expected that most or all tables captions will include the word “Table”, then a keyword-based scoring approach may be appropriate for scoring organizational tables respective to the substantive tables object type. On the other hand, if no keyword or key phrase is expected to be common to most or all image captions, then a positional- or proximity-based scoring approach such as that of Equations (1) and (2) may be more appropriate for scoring organizational tables respective to the images object type.

With reference to FIG. 1, the organizational tables labeler 44 assigns a table type label to each organizational table based on the scores assigned to that organizational table by the organizational tables scorer 42. The output of the organizational tables labeler 44 is a set of one or more labeled organizational tables 46. Various techniques can be employed for labeling the organizational tables. In one approach, a threshold is used: if the score of an organizational table respective to a selected object type is greater than a selected threshold value, then the organizational table is assigned a table type corresponding to that object type. This approach has the disadvantage that it is possible that a given organizational table may have scores satisfying the threshold value for two or more different object types. In such a conflict, the absolute scores are optionally used to select one table type over the other. Alternatively, the user can be informed of such a conflict via the user interface 26, and can select one table type over the other via the user interface 26.

If it is known that there is no more than one organizational table corresponding to each object type (e.g., at most a single table of figures, at most a single table of tables, and so forth), then this information can be incorporated into the labeling process performed by the organizational tables labeler 44. In one approach, the scores of the organizational tables for each object type are ranked from highest to lowest, and the highest-ranked organizational table for each object type is labeled with the corresponding table type. If the highest score is below a selection threshold for a particular object type, then it may be assumed that none of the organizational tables in the document correspond to that object type.

The linked text fragments of a table of contents will generally not be closely associated with objects of any object type. Accordingly, an organizational table that is a table of contents will typically have positionally- or proximity-based scores for the various object types that do not satisfy the selection criterion for any object type. One suitable approach for identifying a table of contents when using positionally- or proximity-based scoring is to assign the table of contents table type to any organizational table that does not satisfy the selection criterion for any object type. In another approach for labeling tables of contents when using positionally- or proximity-based scoring, the selection process is first applied for assigning table types corresponding to object types until all object types have been processed. Any left-over organizational tables (that is, organizational tables that have not been assigned a table type corresponding to any object type) are assigned the table of contents table type by default.

Alternatively or additionally, the organizational tables can be scored respective to the table of contents table type using a keyword- or key phrase-based scoring approach. For example, if the document is known to be organized by chapters, then a keyword-based scoring approach in which a count of the linked text fragments associated with an organizational table that contain the keyword “Chapter” is divided by a count of the total number of linked text fragments associated with the organizational table should provide accurate scoring for the organizational tables respective to the table of contents table type.

With reference to FIG. 1, the labeled organizational tables 46 can be used in various ways. In one approach, the linked text fragments corresponding to each organizational table are labeled or annotated by a label or annotation indicative of the table type. For example, the linked text fragments associated with a table of figures are suitably each labeled or annotated by the phrase “Figure Caption”. In an extension of this approach illustrated in FIG. 1, a document organizer 70 structures the document in XML or another structured representation in accordance with a document type definition (DTD) or schema 72 that that incorporates the object types (e.g., figures, images, tables, or so forth). The result is a document 74 structured by the DTD or schema 72.

The disclosed approaches for labeling organizational tables have been applied to PDF documents that contain organizational tables including tables of contents and tables of images. The PDF documents were first converted to XML with a converter that extracted the images and inserted tags indicating bounding boxes for each image on the page. In test runs using five different documents and a positional- or proximity-based scoring approach, the table of images was correctly labeled each time.

The organizational tables scorer 42 and organizational tables labeler 44 should be configured to be sufficiently sensitive to accurately label organizational tables without producing an excessive number of “false positives” in which an organizational table is improperly labeled. For example, in one test run on a document that contained images but no table of images, the method employing a positional- or proximity-based scoring approach nonetheless labeled a table of images. Such false positives can be reduced by optimizing parameters such as the threshold or other selection criterion with respect to a collection of training documents having expected “average” characteristics. In general, making the selection criterion more rigorous (e.g., increasing the threshold for a scoring approach in which a higher score indicates more likely labeling) will reduce false positives. However, if the selection criterion is too rigorous, then the algorithm may fail to properly label existing organizational tables. Incorporation of a scoring component that reduces the score (or otherwise modifies the score away from satisfying the selection criterion) when there is an element or object intervening between the linked text fragment and the nearest object of the object type being scored is also expected to reduce false positives.

The disclosed techniques for labeling organizational tables are expected to be robust against the relatively common situation in which the number of objects of a selected type is different from the number of entries in the corresponding organizational table. Such a situation may arise due to inclusion in the document of additional objects of a particular object type that are not indexed in the corresponding organizational table, or may arise due to spatial overlap of objects, or so forth. Errors in the text fragmentation performed by the text fragmenter 12 can also produce such differences.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. An apparatus for processing one or more organizational tables of a document, each organizational table including a substantially contiguous sub-set of text fragments of the document identified as entries of the organizational table, each entry having an associated linked text fragment, the apparatus comprising:
an organizational tables scorer that assigns a score to each of the one or more organizational tables respective to at least one object type based on a scoring criterion for that object type; and
an organizational tables labeler that assigns a table type label to each of the one or more organizational tables based on the scores.

2. The apparatus as set forth in claim 1, wherein the organizational tables scorer assigns scores for the organizational tables respective to a selected object type based on proximity of the linked text fragments associated with the entries of each organizational table with objects in the document of the selected object type.

3. The apparatus as set forth in claim 2, further comprising:
at least one object detector corresponding to the at least one object type, each object detector configured to identify (i) occurrences of objects of the corresponding object type in the document and (ii) positions of said occurrences in the document.

4. The apparatus as set forth in claim 1, wherein the organizational tables scorer assigns a score for each organizational table respective to a selected object type based on a count of occurrences of a keyword or key-phrase in at least one of the entries of that organizational table and the linked text fragments associated with the entries of that organizational table.

5. The apparatus as set forth in claim 4, wherein the keyword or key-phrase is selected from a group consisting of: “Fig.”, “Figure”, “Table”, and “Panel”.

6. The apparatus as set forth in claim 1, wherein the organizational tables labeler (i) assigns a selected table type corresponding to a selected object type to any organizational table that was assigned a score for the selected object type that satisfies a selection criterion and (ii) assigns a default table of contents type to any organizational table that was assigned scores that do not satisfy the selection criterion for any of the at least one object type.

7. The apparatus as set forth in claim 1, further comprising:
a document organizer that organizes the document in accordance with a document type definition (DTD) or schema that incorporates the at least one object type.

8. A method of processing one or more organizational tables of a document, each organizational table including a substantially contiguous sub-set of text fragments of the document identified as entries of the organizational table, each entry having an associated linked text fragment, the method comprising:
scoring each organizational table respective to at least one object type based on proximity of the associated linked text fragments of the organizational table to objects of the at least one object type; and
assigning a table type to each of the one or more organizational tables based on the scores.

9. The method as set forth in claim 8, wherein:
the one or more object types include object types selected from a group consisting of image type, figure type, substantive table type, panel type, and textbox type, and
the table types include one or more table types selected from a group consisting of table of images type, table of figures type, table of tables type, table of panels type, table of textboxes type, and table of contents type.

10. The method as set forth in claim 8, further comprising:
locating objects in the document corresponding to the at least one object type, the locating including deriving positional information for each located object that is used in the scoring.

11. The method as set forth in claim 8, wherein the scoring comprises:
(i) selecting a first organizational table and a first object type;
(ii) computing a quantitative proximity measure for each linked text fragment respective to a closest object corresponding to the first object type;
(iii) combining the computed quantitative proximity measures for the linked text fragments of the first organizational table to obtain a score for the first organizational table respective to the first object type; and
(iv) repeating the selecting operation (i), computing operation (ii), and combining operation (iii) for each object type and for each organizational table to obtain scores for each organizational table respective to each object type.

12. The method as set forth in claim 11, wherein the assigning comprises:
labeling organizational tables with table types corresponding to object types based on the scores for the organizational tables respective to the object types.

13. The method as set forth in claim 12, wherein the assigning further comprises:
default labeling any organizational table that is not labeled by the labeling operation as a table of contents type.

14. The method as set forth in claim 8, further comprising:
structuring the document in accordance with a document type definition (DTD) or schema based on the assigned table types.

15. The method as set forth in claim 8, further comprising:
labeling the linked text fragments associated with each organizational table with labels based on the table type assigned to that organizational table.

16. An apparatus for structuring a document, the apparatus comprising:
a text fragmenter configured to extract an ordered sequence of text fragments from the unstructured document;
an organizational tables extractor configured to extract one or more organizational tables from the ordered sequence of text fragments, each organizational table including a substantially contiguous sub-set of text fragments of the document identified as entries of the organizational table, each entry having an associated linked text fragment;
an organizational tables labeler configured to assign a table type label to each organizational table based on at least one of (i) content of at least one of the entries and the linked text fragments and (ii) proximities of the linked text fragments with respect to objects in the document; and
a document organizer configured to structure the document based on the labeled organizational tables.

17. The apparatus as set forth in claim 16, further comprising:
an objects detector configured to detect objects in the document and to derive information for each detected object including (i) a position of the object in the document and (ii) an object type, the organizational tables labeler receiving and using the derived information in determining the proximities of the linked text fragments with respect to objects in the document.

18. The apparatus as set forth in claim 17, wherein the objects detector is configured to detect and derive information for objects of at least two different object types selected from the group consisting of: images, figures, substantive tables, panels, and textboxes.

19. The apparatus as set forth in claim 16, wherein the organizational tables labeler is configured to (i) compute a proximity measure for the linked text fragments associated with the entries of each organizational table respective to each of two or more different object types and to (ii) assign the table type label based on the computed proximity measures.

20. The apparatus as set forth in claim 19, wherein the organizational tables labeler is configured to assign a default table of contents label to any organizational table for which no other table type label is assigned.
